(19) United States
(12) Patent Application Publication
(10) Pub. No.: US 2024/0213834 A1
(43) Pub. Date: Jun. 27, 2024

(54) Permanent Magnets with Integrated Phase Change Materials

(71) Applicant: National Research Council of Canada, Ottawa (CA)

(72) Inventors: Jean-Michel Lamarre, Quebec (CA); Maged Ibrahim, Cairo (EG); Fabrice Bernler, Quebec (CA); Roger Pelletier, Quebec (CA)

(73) Assignee: National Research Council of Canada, Ottawa, ON (CA)

(21) Appl. No.: 18/288,882

(22) PCT Filed: May 20, 2022
(86) PCT No.: PCT/IB2022/054752

§ 371 Date: Oct. 30, 2023

Related U.S. Application Data
(60) Provisional application No. 63/190,871, filed on May 20, 2021.

(51) Int. Cl. H02K 1/2793; B33Y 10/00; B33Y 80/00; H02K 1/02; H02K 15/03

(52) U.S. Cl. CPC H02K 1/2793; B33Y 10/00; B33Y 80/00; H02K 1/02; H02K 15/03; H02K 2215/00

(57) ABSTRACT

A permanent magnet (PM) for use in an electric machine including at least one cavity containing a phase change material (PCM) integrated with said PM, the PCM having a phase transition temperature between about 80° C. to about 200° C., and preferably a latent heat of at least 50 KJ/kg, wherein in PM, each cavity is a blind, elongated chamber extending from one side of the PM, having two smaller dimensions and a larger dimension of each cavity is oriented substantially in a same direction, wherein the PM is composed of a hard magnetic phase, a binder phase and PM having an ultimate tensile strength of at least 150 Megapascal (MPa), wherein PM is mounted on a rotor of an electric machine and is formed by cold spray additive manufacturing (CSAM)

### FIELD

The present disclosure relates generally to permanent magnets for use in electric machines. In particular, the present disclosure relates to permanent magnets for use in electric machines containing phase change material integrated with the permanent magnet.

### BACKGROUND

Canadian Patent Application 2, 118,539 to Muhlberger et al. teaches an AC generator having, in some embodiments, phase transition materials incorporated into insulating rings of a rotor, proximal to permanent magnetic (PM) materials. The rotor includes alternating rings of PM and enclosures for PCMs. Applicant takes ‘phase transition materials’ to be synonymous with phase change materials (herein PCMs). The challenges of incorporating PCMs directly into PMs is not addressed, nor addressable by, Muhlberger et al., and consequently substantially less effective cooling is produced. For cooling, high-surface-area direct contact to a heat sink is vastly superior to coupled, remote, contact.

This section is intended to introduce various aspects of the art, which may be associated with the present disclosure. This discussion is believed to facilitate a better understanding of particular aspects of the present disclosure. Accordingly, it should be understood that this section should be read in this light, and not as admissions of prior art.

Magnetic performance of permanent magnets such as NdFeB permanent magnets used in electric motors are known to rapidly decrease as operating temperature increases. This limits the power output of motors as their operating temperature rapidly increases with increasing power demand. This is particularly problematic for applications where high peak power is required for relatively short periods of time, for example during a highway acceleration or during an airplane's take-off.

It is well known that higher grade magnets—typically composed of a higher fraction of heavy rare earth elements (e.g. Dy or Tb)—are less prone to demagnetization and thus withstand higher maximum operating temperatures. Higher grade magnets are more expensive and their price is volatile. Furthermore, even the highest grade of NdFeB magnets have maximum operation temperature around 170° C. Therefore it is desirable to employ temperature rise limiting (TRL) strategies in electric machines. TRL strategies typically include cooling systems provided by thermal fluid circulation (typically liquid), that is limited to features in stators of electric machines as it is impractical to route a liquid in a rotor part operating at a variety of speeds up to several thousand RPM. TRL strategies for the rotor component usually relies on the natural heat transfer between the rotor and cooled stator. It is known, as explained hereinabove, to prevent rotor overheating with PCMs, but integration of PCMs within PMs, is not known.

It follows that costs of motor manufacture are strongly affected by material costs of magnets. Design possibilities are restricted by the shape and positioning of magnets that can be provided by the manufacturing techniques. Conventionally PMs are produced by powder metallurgical forming and sintering, however these methods do not admit formation on rotors and therefore a separate step of mounting the PMs to the rotor is typically required: mounting is typically provided by adhesives, slotting or screws. Handling, aligning, bonding and machining the PMs is limited by their mechanical properties.

For current purposes, the principal shortcoming of PM materials formed by powder metallurgy is their combination of low ultimate tensile strength, brittleness and low ductility, which herein is termed frangibility. The frangibility of typical high grade PM materials introduces many practical and cost limitations on design and feature size and geometry that can be mounted to rotors in low-cost, fast, quality-assured processes. Thus fabrication cost, machining limitations and mechanical integrity requirements lead to relatively simple, somewhat stubby, PM shapes.

These shape limitations are most troublesome for designing integrated TRL systems, regardless of method of assembly of the PM components. TRL inherently, and unavoidably, produces a temperature gradient locally within the PM, which can increase thermal stresses. Providing cavities and recesses that bring the PCM in most intimate contact with PM materials (where thermal control is most in need) can produce thin necks of PM materials that increase risks of fracture.

The use of additive manufacturing (AM), and particularly cold spray additive manufacturing (CSAM), to form PM parts can address many issues. CSAM can co-deposit a metal like Cu or Al (or alloys thereof) along with a PM powder at a rate of several kg/hour. The metal incorporated into the material improves deposition efficiency, and produces PMs with improved thermal conductivity, and greatly reduced frangibility. CSAM can build up PM parts directly onto rotors, and can provide high adhesion strength, and high reliability thereof. Deposition on the rotors themselves avoids a complex assembly step. Any problems with adhesives or assembly, which can limit heat transfer from PM to rotor, or can intrude into PCM cavities, are avoided. Design of the PM can provide for more strategic localization of PM materials, with less risk of delamination or separation of the PM from the rotor. Many of the assembly risks, much of the workload, and the design limitations can be avoided with these less frangible, and more reliably adhered PMs. The use of PM materials having higher resilience to stress is highly desirable for the incorporation of more effectively positioned PCM within PMs, and the reduction of usage of expensive PM materials.

There therefore remains a need for an alternative approach to TRL in general and for more effective local cooling of PMs in electric machines, especially in rotary elements.

### SUMMARY

In an aspect of the present disclosure, there is provided a permanent magnet (PM) for use in an electric machine, said PM containing a phase change material (PCM) integrated within said PM, the PCM having a phase transition temperature between about 80° C. to about 200° C.

In respective embodiments, said PCM can be characterized as: having a phase transition temperature between 150° C. to about 250° C.; having a latent heat of at least 50 KJ/kg; or composed of Paraffin, Erythritol or a combination thereof.

In an embodiment, the permanent magnet is composed of a hard magnetic material comprising a hard magnetic phase, and a binder phase. In an embodiment, said hard magnetic material consists essentially of an AlNiCo alloy, a NdFeB alloy, a SmCo alloy, a SmFeCo alloy, or a combination thereof. In an embodiment, the hard magnetic material consists essentially of NdFeB, a NdFeB alloy, or a combination thereof. In an embodiment, the binder consists essentially of Al, Cu, Ti, Zn, Fe, Ni, Ag, Au, an alloy thereof, or a combination thereof, more preferably the binder comprises more Al, Cu, Zn, Ni or Fe than any other element. In an embodiment, the binder is Al, or an alloy thereof.

In an embodiment, the permanent magnet is composed of at least about 34 vol % hard magnetic phase, and at least 10 vol % of the binder, with at least 70% of the composition consisting of the binder and hard magnetic phases. At least 51 vol % of hard magnetic phase is required for most applications, and around 75 vol % has been demonstrated in reasonably efficient processes, although higher volume fractions of hard magnetic phase are possible with some deposition processes, for example as high as 85 vol %. Those skilled in the art will recognize that volume fraction of the hard magnetic phase can be increased to improve magnet remanence, possibly at the expense of mechanical properties provided by the metallic binder. Furthermore technological improvements are expected to lead to higher hard magnetic phase volume fraction with greater deposition efficiency.

In respective embodiments, the PM contains one or more cavities in which the phase change material is integrated; such as 1 to 10, or 5 to 10 of said cavities.

In an embodiment, each of the cavities is a blind, elongated chamber extending from one side of the PM, having two smaller dimensions and a larger dimension, the larger dimensions of each cavity are oriented substantially mutually in parallel, or each may be locally normal (within)+/−15° to a surface of the PM. Each cavity may have a cylindrical, or a frustoconical shape, consistent with production by drilling of the PM.

In another embodiment, each of the cavities extends a substantially constant (e.g. +/−15%) distance from the surface of the PM, be it on a surface, or a subsurface cavity.

In an embodiment, the PM is mounted to a rotor for an electric machine. To the extent that the cavities are elongated, they may preferably extend parallel to a rotor axis, or azimuthally (circumferentially) around the axis, as opposed to radially. The PM may be consistent with formation by AM, preferably with CSAM. The rotor may be mounted to an axle and to a stator to produce an electric machine.

In an embodiment, the permanent magnet is made by additive manufacturing, such as cold spray additive manufacturing.

Another aspect of the disclosure is a method of manufacturing a permanent magnet, said method comprising: providing a permanent magnet material, and forming the permanent magnet by additive manufacturing directly on a substrate using the permanent magnet material; finishing the PM and producing or finishing a cavity within the PM for retaining a phase change material; integrating the phase change material into the permanent magnet; and enclosing the cavity.

In an embodiment of the method, said producing or finishing a cavity comprises forming a cavity in said permanent magnet. In an embodiment, the additive manufacturing further comprises: depositing said phase changing material in solid form, or depositing said phase changing material in powder form and then curing said powder, pouring phase changing material in liquid form and then solidifying said liquid form. In an embodiment of the method, forming the permanent magnet comprises: sequentially building up the permanent magnet defining the cavity using the permanent magnet material.

In an embodiment, enclosing the cavity further comprises closing said cavities using a machined press-in or screw-in cap.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached figures, in which:

FIG. 1a,b respectively depict a 2D schematic representation, and a 3D model, of a half of a permanent magnet motor for an electric vehicle which may be adapted in accordance with the present invention, the motor having 10 rotor poles and 12 windings;

FIG. 2a depicts the torque speed curve of the motor of FIG. 1 as well as different motor operation points corresponding to different driving conditions;

FIG. 2b depict different motor loss components for the operation points;

FIGS. 3a-c respectively depict a half motor assembly schematic according to an embodiment of the invention, including principal motor parts, said schematic labelled to identify different heat transfer hypotheses and air gap dimensions were used in simulations of embodiments of the present invention; respectively illustrating a 3D model of the motor assembly, and side and top views;

FIG. 4a is a schematic typical Heat Capacity vs. Temperature curve for a phase changing material;

FIG. 4b is a bar chart showing ultimate tensile strength of cold sprayed additive manufactured PM materials in comparison to some other PM materials;

FIG. 5a is a graph showing the simulated average magnet side temperature increase as a function of time during an uphill drive scenario, with and without the integrated PCM;

FIG. 5b shows the same feature of the same simulation system observed during a highway acceleration scenario;

FIG. 6 depicts the simulated magnet temperature distribution after 15 s of uphill drive scenario with and without the integrated PCM;

FIG. 7 is a graph of magnet side temperature throughout a simulated electric vehicle operating scenario where a motor is operated in steady state one hour, the motor is operated at a peak demand for 60 seconds, and then operated in steady state again for another 1 hour duration; FIG. 7a shows an enlargement the graph of FIG. 7 providing a close-up view over the time period corresponding to the peak demand to clearly show the temperature reduction with the PCM;

FIG. 8a shows the simulated average and maximum magnet temperatures under the motor operating scenario presented in FIG. 7; FIG. 8b shows a close-up view for the time period corresponding to the peak demand; and FIG. 8c is a graph of a percentage of effective phase change material that is molten (above 118° C.) during the high power demand period, showing that only 10.5% of the total PCM volume is effective in the PCM configuration of FIG. 9a, in this scenario;

FIGS. 9a-c show 3 segmentation examples of the permanent magnet for better TRL, according to an embodiment of the invention;

FIG. 10a is a multi-graph of a thermal transient analysis of the permanent magnet without PCM and the 3 segmentation examples of FIGS. 9a-c; FIG. 10b is a histogram showing the transient time to reach 150° C. for the 3 segmentation examples of FIGS. 9a-9c; and

FIG. 11 is a temperature distribution at a 90 second data point of the simulated process shown in FIG. 10a;

FIG. 12 is a panel comparing a segmented PM design with an integrated cavity PM design according to an embodiment of the present invention; the panel comprising side-by-side, for the two PM designs: side elevation views, temperature distributions during simulation at corresponding moments in a scenario; and heat flux vector plots showing heat flux at corresponding moments in a scenario;

FIG. 13 is a temperature vs. time plot for the designs of FIG. 12, illustrating the small difference provided by integration of the PCM into the PM for TRL purposes;

FIG. 14 is a side elevation view of a variant of the integrated cavity PM design featuring a rounded top surface, the cavities provided by bore holes drilled from two opposite sides, one of which being capped; and FIG. 14a is a cross-sectional view of the PM design of FIG. 14, cut through line AA, showing an arrangement of longitudinal cavities buried in the PM;

FIG. 15a is a schematic cross-sectional view through a second variant of the PM design featuring 5 frustoconical cavities of two different sizes, each provided as if bored by a tapered bit from a different respective angle, each angle being normal to a surface of the PM part; and FIG. 15b is an end view of the PM of FIG. 15a;

FIG. 16 is a schematic cross-sectional view showing a third variant PM design featuring an elongated cavity recessed from a top (as shown) surface by a constant distance, as well as two side cavities of variable, but monotonically decreasing diameter with distance from the respective side surfaces from which they extend; and

FIG. 17 is a schematic section view showing a fourth variant PM design, the fourth variant featuring two surface ridges running a fixed depth into sides (as shown) of the PM, and two low height fan shaped recesses extending as blades into the middle of the PM.

It should be noted that the figures are merely examples and no limitations on the scope of the present disclosure are intended thereby.

### DETAILED DESCRIPTION

As used herein, the terms ‘PM(s)’, ‘magnet(s)’ ‘hard magnet(s)’ and ‘permanent magnet(s)’ are used interchangeably to refer to (a) permanent magnet(s).

As used herein, ‘NdFeB’ refers to a hard magnetic material of, or for forming, a PM part, and may be otherwise represented as ‘FeNdB’, or any other order (or ratio) of the elements Nd, Fe, and B. In some embodiments, other elements may be added to the hard magnetic powder NdFeB to control particular properties, such as high temperature stability.

As used herein, ‘PCM’ refers to a phase change material.

As used herein, ‘TRL’ refers to temperature rise limiting, an adjective qualifying a system, strategy or structure that reduces a tendency to a PM overheating during operation, particularly at high torque loads, or over bursts, or short periods of, high heat output.

Generally, the present disclosure provides a PM containing a phase changing material integrated therein. The phase changing material may limit the temperature rise of the PM during operation. The PM can be used in applications such as electric machines and in particular electric motors. The electric motors may be used in electric ground vehicles or in aircraft (including piloted, remotely piloted, autonomous, or any hybrid thereof; whether for human cargo or occupant, or operator, or not, and whether aerodyne (fixed wing or rotorcraft) or aerostat or hybrid thereof). Advantageously, the PCM is integrated into the PM's structure and incorporated into a rotor of an electric motor.

The present inventors found that the PCM reduces the temperature rise of the PMs when PCMs are integrally retained within, or integrated with, the PM. By integrated with, Applicant intends that the PCMs are surrounded by walls of the PM, in that at least 80% of the surface area of the PCM are adjacent the PM. Preferably the PCMs are enclosed by at least 4 sides by the PM, more preferably 5 sides.

PCMs are materials having high latent heat that can accumulate a large amount of energy (see FIG. 4a) that is absorbed once any part of the PCM reaches a phase transition temperature. In accordance with the present invention, that temperature is chosen for TRL of the electric machine under peak operating conditions. To be useful on today's PM materials, the phase transition temperature is less than 200° C. (e.g. about 170° C. for the highest grade of NdFeB).

Without being bound by theory, it is believed that the integrated PCM reduces a maximum temperature of the PMs by acting as an energy storage buffer particularly during short phases where peak power is required from the motor. Operation of the motor allows for accumulated heat to dissipate after the peak-power event.

The PMs of the present disclosure with integrated PCM can be used in different modes and configurations to achieve several motor performance improvements or cost reductions. For example, the maximum temperature reduction can advantageously allow the use of lower cost magnet grades that are less stable at higher operating temperatures, to reduce motor cost. PMs with integrated PCM can also advantageously be used in combination with higher coil current to improve the motor peak power output while maintaining the maximum magnet temperature constant. Motor characteristics can also be tailored using the PCM, which can allow positioning of the PCM in different configurations. Given a high ultimate tensile strength of PM materials composed of a metal binder and hard magnetic powder, the shape limitations on the PM can be relaxed. The PCM integrated into the PM can be used as a motor built-in safety feature to prevent PM temperature overshoot.

FIG. 4b is a bar chart showing a degree to which cold spray additively manufactured (but not heat treated or otherwise optimized) PM materials may have a higher ultimate tensile strength (UTS) than sintered, bonded (either by injection molding or compression molding with binders) or big area additive manufacturing. While all of these fabrication methods admit of binders, the parts formed are not always formed bonded to a substrate (or rotor), and all binders cannot work with all processes, and as demonstrated, CSAM provides metal binders that improve deposition efficiency of the cold spray process, while providing a material with excellent strength 210 MPa, as well as 355+/−7 MPa transverse rupture strength. The material exhibits elastic deformation, but has limited plastic deformation before rupture. Thus while a variety of PM materials with metal binders are expectedly endowed with mechanical properties well suited to alleviate the TRL issues with current PMs, it is expected that further improvements, with reduced binder loads, and even further improvements in ductility are within reach currently, and will be further developed over the patent life. The present preferred methodology for the CSAM fabrication of the magnets involve the pre-mixing of the magnetic powder (i.e. NdFeB) with the binder powder (i.e. Al) using a predetermine weight ratio of: 90% NdFeB to 10% Al. This ratio is chosen to maximize the hard magnetic phase volume fraction while maintaining sufficient deposition efficiency for industrial application. The mixed powder is processed in the CSAM equipment with a pressurized gas at a temperature of 600 to 800° C. and a pressure of 4.9 MPa. One skilled in the art will recognize that the optimum weight ratio can be significantly altered by a different choice of powder morphology, size and composition as may be commercially available and by the spray parameters as dictated by process limitation such as nozzle clogging and maximum system pressure.

The present inventors found that it is difficult to integrate a PCM in a traditional magnet fabricated by compaction. Indeed, PCMs become liquid during a phase transition and as they are subject to centripetal forces mounted to a rotor, a retaining structure is required. Traditional sintered magnets are brittle, difficult to machine, and their shape is limited to simple geometries rendering the fabrication of structures suitable to accommodate a PCM, impractical. On the other hand, complex hollow structures can be built into, or machined into, PMs fabricated by additive manufacturing, or otherwise consisting essentially of a metal binder and hard magnetic powder, allowing designers to position more effectively the PCMs and to contain them.

The present invention also provides a method of manufacturing a PM having a PCM integrated therein. The method comprises manufacturing a PM through additive manufacturing, such as cold spraying. The PM is advantageously fabricated directly onto a substrate without the need for further assembly. The PCM is then integrated into the magnet.

There are several ways of integrating the PCM into the PM that is made through additive manufacturing.

For example, the PM may be directly fabricated using additive manufacturing with cavities in which the PCM is inserted. The PCM may become liquid if it reaches its melting point temperature. The PCM would therefore remain in the cavity of the PM to absorb energy throughout its phase change thus limiting the peak temperature. Advantageously, and in contrast with methods currently available in the art, the PCM is a material that does not require any circulation in the PM thus eliminating the need for routing the material to the rotor structure, for connecting fittings and more importantly for a pumping apparatus that can operate in the variable centrifugal environment. The resulting structure: may be free of additional moving parts; does not require the use of additional power or control systems, thus improving the rotor weight; and is generally less prone to failures and leaks and could be used for many cycles without maintenance provided that the PM stays within its pre-set operating temperature range.

The present disclosure further describes a PM, a rotor, or electric machine comprising the PM, and methods of manufacturing the PM. Additive manufacturing may allow for the design and production of PMs having complex geometries, such as by the cold spraying of a Metal-NdFeB composite. As described herein, additive manufacturing, such as cold spray, allows for the PCM to be integrated into, or embedded into a PM. The PCM may advantageously be integrated through cavities that are built into the PM then filled with PCM. In addition, the methods described herein provide for magnets to be fabricated directly on a surface; for example, a rotor of an electric motor, hence eliminating an insulating air or adhesives interface. This is demonstrated herein below to improve thermal conductivity even more than the aluminum binder content.

In an embodiment, there is a method of manufacturing a PM, comprising providing a PM material, and forming the PM and a cavity by additive manufacturing directly on a substrate. The PCM is then inserted or poured into the cavity. The cavity can be closed using for e.g. a machined press-in or screw-in cap, or any suitable cover.

The method of manufacturing a PM may involve forming the PM iteratively, i.e.: sequentially building up the PM defining the cavity using the permanent magnet material. The PCM can then inserted or poured into the cavity.

In another embodiment, there is provided a method of manufacturing a PM wherein the substrate is a metallic substrate. In another embodiment, the metallic substrate is an aluminum-based substrate, an iron-based substrate, a copper-based substrate, or a combination thereof.

In another embodiment, there is a PM is made of a powder composition comprising a hard magnetic phase and a metallic binder. The hard magnetic phase may be composed of an AlNiCo alloy, a NdFeB alloy, a SmCo alloy, a SmFeCo alloy, or a combination thereof. The hard magnetic powder may comprises NdFeB, a NdFeB alloy, or a combination thereof. In an embodiment, the binder consists essentially of a pure metal or alloy of Al, Cu, Ti, Zn, Fe, Ni, Ag, Au, or a combination thereof, more preferably the binder comprises more Al, Cu, Zn, Ni or Fe than any other element. In an embodiment, the binder is Al, or an alloy thereof. The PM powder composition preferably comprises approximately 34 vol % to approximately 85 vol % hard magnetic phase. Applicant has demonstrated CSAM PMs bearing about 75 vol % of hard magnetic phase. Preferably the binder and hard magnetic phase compose at least 70 vol % of the PM.

In another embodiment, the method of manufacturing a PM employs CSAM to build up the PM.

In an embodiment, the PCM may have a latent heat of at least 50 KJ/kg. The PCM may be selected from Paraffin, Erythirtol or a combination thereof. Table 1 below shows properties of these 2 exemplary PCMs:

TABLE 1

| | Paraffin | Erythritol |
|---|---|---|
| Density [kg/m3] | 1000 | 1450 |
| Thermal conductivity [W/(m · ° C.)] | 0.2 | 0.5 |
| Solid specific heat [kJ/(kg · ° C.)] | 2 | 2.2 |
| Liquid specific heat [kJ/(kg · ° C.)] | 3.3 | 2.6 |
| Latent heat [kJ/kg] | 250 | 319 |
| Melting point | Up to 90° C. | 118° C. |

In another embodiment, a PM formed by the method as described herein is provided. In another embodiment, a use of the PM as described herein for manufacturing an electric machine is provided.

In another embodiment, there is provided a use of the PM as described herein for operating an electric machine. In another embodiment, there is provided a use of the PM as described herein wherein the electric machine includes an electric motor or an electric engine such as an electric vehicle or an aircraft.

### Cold Spray Additive Manufacturing

Cold spray is a process where a material is built onto a substrate by the deformation and bonding of particles impacting a substrate at high velocities. Generally, particles are accelerated using a heated, high pressure gas, such as nitrogen, that is fed through nozzle typically using a de Laval configuration. The gas temperature may be heated to hundreds of degrees Celsius; however, the actual particle temperature remains much cooler. Particle speeds of several hundred meters per second may be obtained, which tends to build materials that are very dense (typically <1% porosity), and exhibit adhesion values generally higher than what can be obtained using most any other technology, and denser than can be achieved with press and sinter techniques.

The density is also essential for the production of high ultimate tensile strength materials, such as those with UTS>120 MPa, or greater than 150 MPa or even 200 MPa. Applicant has found that sintered PM composites typically have UTS<80 MPa (see FIG. 4b). Other techniques for additively manufacturing, or hot, cold or warm compaction of metal powders with NdFeB (or presumably with AlNiCo, SmCo, or SmFeCo) are expected to produce PMs with equally limited UTS.

In an embodiment, a cold spray process may be carried out using a Plasma Giken 800 gun, with a main gas temperature of about 400° C. to about 800° C., or about 600° C. to about 700° C. and a maximum pressure of about 5 MPa, or about 3 MPa to about 5 MPa. In another embodiment, a spray distance of about 80 mm to a surface may be used. In another embodiment, methods of cold spraying a permanent magnet powder composition may be fully automated; for example, using a robot and robot programing. In such an embodiment, the robot traverse speeds and steps may be dependent on the geometry of the PM being manufactured. As understood by those skilled in the art, the set temperatures, pressures, spray distances, etc. depend on the magnetic powder composition.

In an embodiment, the permanent magnet powder composition comprises a hard magnetic powder and a binder. In another embodiment, the hard magnetic powder may comprise NdFeB. In another embodiment, the binder may be the metal M as described above, to provide an increased disposition efficiency, good thermal conductivity, and corrosion/oxidation protection. In another embodiment, the binder or metal M may be an aluminum-based alloy, such as an aluminum powder.

In an embodiment, the permanent magnet powder (feedstock) composition may comprise a minimum of approximately 34 vol % hard magnet powder. In another embodiment, the permanent magnet powder composition may comprise of approximately 34 vol % hard magnetic powder, or approximately 51 vol % hard magnetic powder, or up to approximately 99 vol % hard magnetic powder. In another embodiment, the permanent magnet powder composition may comprise up to approximately 1 vol % binder, or up to approximately 25 vol % binder, or up to approximately 49 vol % binder, or up to approximately 66 vol % binder. In a further embodiment, the permanent magnet powder composition may provide for an M-NdFeB composite PM.

In an embodiment, during the spray process, care is taken to minimize a rise in temperature of the magnetic powder, to limit oxidation and magnetic property degradation. In another embodiment, the spray process is carried out with an aim to maintaining low coating porosity, and a good deposition efficiency.

In an embodiment, commercially available NdFeB base powders may be used. In another embodiment, commercially available binders, for example pure aluminum powder may be used. Powder size distribution of said aluminum powder may vary. Suitable NdFeB magnetic powders include, but are not limited to: Magnequench MQP-S-11-9; MQFP-B; MQFP-14-12; MQP-AA4-15-12; MQA-38-14; and MQA-36-18.

PMs Comprising Cavities in which the PCM is Deposited

Herein described are methods for producing PMs comprising cavities using, for example, cold spray additive manufacturing. Further described are PM devices (for example, PM motors) comprising PMs with PCM-containing cavities. In some examples, the PMs define a cavity in which the PCM is deposited.

PMs (for example, NdFeB) are traditionally fabricated using techniques such as compaction and sintering. Subsequently, they are machined in order to meet tolerances, and are installed and fitted on a part as needed (for example, an electric motor stator or more preferably rotor). Such methods restrict a magnet's achievable configurations. Use of additive manufacturing processes, such as cold spray, allows for a 3D buildup of magnets having complex shapes, with little to no cost and/or production time increase. Such additional flexibility permits implementation of geometries that would be otherwise technically difficult or impossible to fabricate, or simply cost-prohibitive.

TRL (known more generally as thermal management) is a well-known problem in, for example, electric machines, such as electric motors. Electric currents are needed to generate motion, but undesirable Eddy currents can flow in the metal parts. Both of these contribute to heat generation. When used in such electric machines, the performance of rare-earth PMs degrade rapidly when operating temperatures exceed 100° C., and can eventually lead to demagnetization of the magnet and failure of the machine. In order to minimize this effect, heavy rare earths (such as Dysprosium) are added to the magnet composition to stabilize the magnet's high temperature properties at the expense of overall performance.

As described herein, additive manufacturing is used to fabricate PMs comprising cavities in which the PCM is inserted, wherein the geometry (e.g., shape, size, etc.) of the cavities depends on the geometry of the magnet and its intended application. Cold spray, or another manufacturing technology such as laser sintering, laser cladding, direct-write, extrusion, binder jetting, fused deposition modelling, etc. may be used to build the 3D shape of a magnet. Cavities are formed, for example, by any one or combination of the following methods:
(I) Direct formation of a cavity, involving directly forming cavities using an additive manufacturing technique. In respect of cold spray, direct formation requires use of an appropriate toolpath comprising a build-up of material using various deposition angles in order to realize a desired structure for a cavity defined within a magnet. Directly formed cavities on or near an outer surface of the PM, or at an interface between the PM and rotor, are particularly favourably fabricated.
(II) Embedding of custom tubing to form a cavity, involving installation of custom geometry tubing channels within a magnet. Tubing is banded and shaped into a correct geometry, and installed on a previously fabricated, yet incomplete 3D magnetic structure. Structure is completed by addition of PCM directly into the tubing. The tubing is preferably either composed of a PM to cooperate with the PM being deposited, substantially non-responsive to electric and magnetic fields to avoid losses or redirection of magnetic flux, or removable after additive manufacture to minimize impact on performance of the PM.
(III) Use of sacrificial material to form a cavity. Similar to the installation of custom tubing, a sacrificial material is shaped into a correct geometry, but is removed after fabrication of the magnet. The sacrificial material may be applied by different techniques including additive manufacturing, such as cold spray. The sacrificial material may be removed by being melted, and subsequently removed under the influence of gravity or applied pressure. By reference Applicant hereby incorporates the teachings of Applicant's U.S. Pat. No. 11,313,041 which teaches a particular process for AM of parts with sacrificial materials, but Applicant does not wish to limit sacrificial materials to these soft metals. Applicant submits that it is well within the capacity of one skilled in the art to embed bodies formed of a monolithic salt into a PM during additive manufacture, and dissolve the salt after the manufacture.
(IV) Form a PM with a high enough UTS, and machine cavities into the PM through a surface thereon.

Advantageously, PMs comprising cavities are built on a substrate. Such substrates may or may not be sacrificial. Generally, any metallic substrate is suitable for use in manufacturing PMs comprising cavities but ceramic or polymeric substrate can also but used. Iron-based and aluminum-based substrates are among the most commonly used. For example, an aluminum-based substrate may be used in the manufacture of PMs comprising cavities since: (i) it increases heat evacuation due to its high thermal conductivity; (ii) it can provide good deformation for good mechanical properties; (iii) it is relatively inexpensive; (iv) it is oxidation resistant; and (v) is light weight and thus would contribute to reducing the weight of any final assembly. An iron-based substrate such as a soft magnetic composite or a laminated structure may also be used in the manufacture of PMs comprising cavities because it provides good magnetic saturation for the magnetic flux path and is inexpensive. In other examples, a copper-based substrate may be used in the manufacture of PMs comprising cavities as it has good thermal conductivity.

In some examples, PMs having PCM integrated therein may form part of a motor part, such as a rotor, stator, etc. In an example, a PM containing an integrated PCM may be coupled to a surface of a motor part, the PCM at least providing internal temperature control of the magnet. Alternatively, a PM having PCM integrated therein may be coupled to a surface of a motor part. Advantageously the PM having the PCM integrated therein is coupled to the rotor part of the motor.

PMs containing a PCM integrated therein can offer enhanced thermal management capabilities, at least because of:
(I) Enhanced thermal transfer, as the PCM can be positioned directly inside structures that need temperature control (i.e. magnets). Intimate contact that is created favors heat evacuation via direct conduction, thus increasing the effective heat transfer coefficient.
(II) Better temperature uniformity and control, as the PCM can be designed with shapes matching the geometry of the magnets and the desired temperature profile. It can be used to control temperature of magnet regions that are difficult to control using traditional temperature control strategies. It can also be used to adapt the geometry in such a way as to obtain better temperature uniformity, thus protecting against hot spot degradations.
(III) Enhanced thermal conductivity and mechanical properties, as PMs fabricated using cold spray additive manufacturing include a metallic binder (i.e., metal M) that improves the effective composite thermal conductivity while improving mechanical properties.

### EXAMPLES

### Motor Configuration

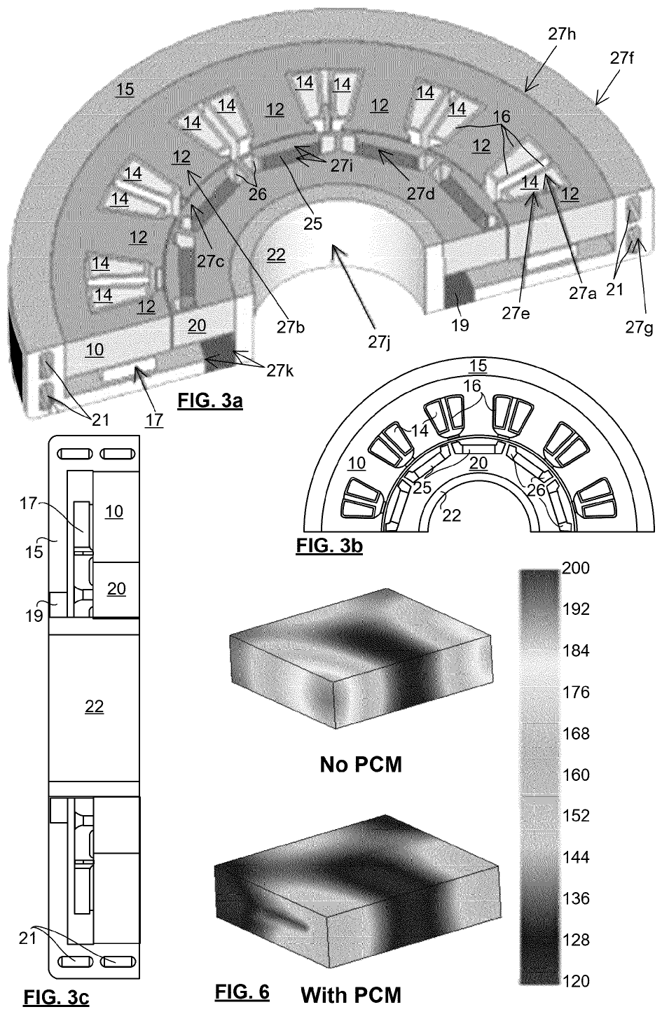

For illustration purposes, a radial flux motor with concentrated stator windings was selected for analysis, although it those skilled in the art will readily envisage application to axial flux motors, as well as generators. The tooth-wound concentrated windings can achieve high copper fill factor and short end-windings (17 visible only in FIG. 3a), leading to high power and torque densities. On the other hand, its high armature harmonics tend to increase rotor losses, leading to rapid magnet temperature rise in operation. As such it is a good candidate for the invention.

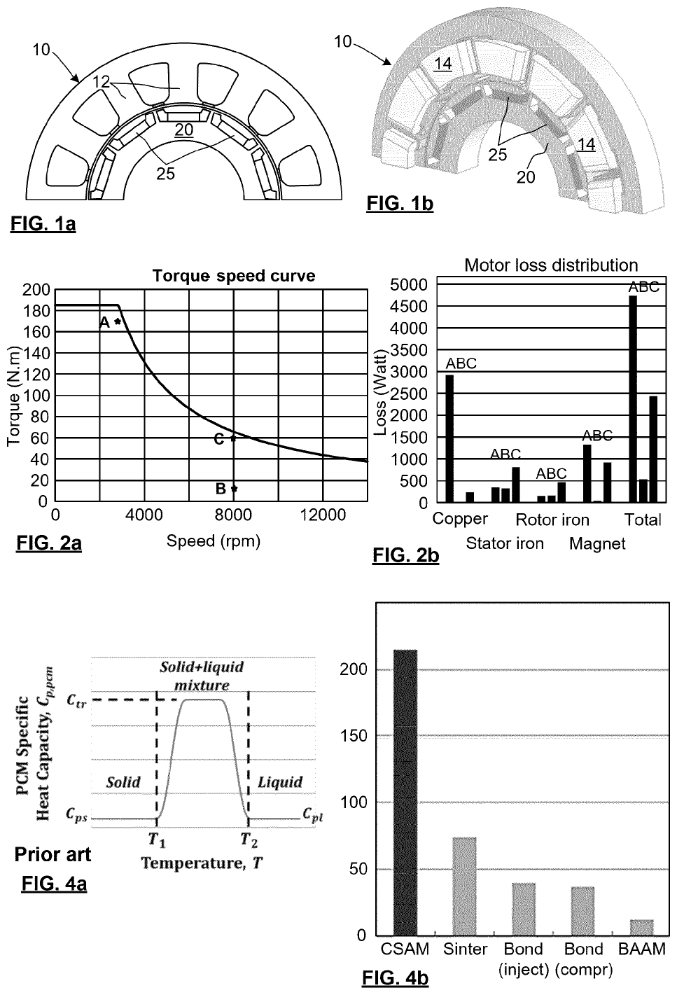

FIGS. 1a,b respectively depict a 2D model and a 3D model of a half of radial PM motor for an electric vehicle according to an embodiment of the present invention. FIG. 1b is the 3D model used for simulation. The PM motor comprises two main parts: a 12 coil stator 10 and a 10 pole rotor 20. The half stator 10 shown has 6 magnetic stator cores 12 (only two of which identified by lead lines) for supporting respective field generating coils 14. The cores 12 are not well in view in FIG. 1b, as the coils 14 cover them, and the coils 14 are not illustrated in FIG. 1a, to show the cores 12 more clearly. The stator core 12 guides magnetic flux produced by the coils 14. The rotor 20 has 5 PMs 25 mounted thereto. In accordance with the present invention, at least one of the PMs 25 is, and typically all of them are, provided with an integrated PCM. This configuration was used for simulation and to illustrate the present invention, although other electrical machine designs could also be used equivalently.

### Simulation of Torque-Speed Curve and Motor Loss Distribution

The motor of FIG. 1 was modeled using finite element analysis (FEA) to extract the motor torque-speed curve characteristics. Three typical driving scenarios, corresponding to three different motor operating points, are identified in FIG. 2a: A—up hill drive (high torque, low speed), B—highway steady state (low torque high speed) and C—highway acceleration (moderate torque, high speed). The corresponding motor losses were simulated and are presented into FIG. 2b. One can observe that the total motor losses are high at operating points A and modestly high at C. All motor losses contribute to the temperature increase of the motor. In particular, the motor losses in the rotor and magnet directly contribute to the temperature increase of the magnets, the copper losses being in the windings 14, are somewhat remote from the PMs, and are typically cooled locally. Thus it will be observed that each of the magnet losses are the most substantial, but not more than the cumulative iron losses.

FIG. 3 (i.e. FIG. 3a showing a 3D half motor structure used for modelling, and FIGS. 3b,c showing top face and side views of the half motor structure) show the components of a complete motor structure. FIG. 3a is labelled to show the boundary conditions used in a thermal FEA model used to examine this electric machine. Specifically FIG. 3a shows the model for simulation of motor of FIG. 1a,b, and is overlaid with identifiers of regions of temperature sensitivity.

The model includes the rotor 20 and stator 10 as before, and the stator is encased by a casing 15, that has embedded coolant channels 21 for cooling the stator 10. The rotor is interference fit to an axle or shaft 22, which is coupled by a bearing 19 to the casing 15. The axle 22 and coils 14 are cut at a top (as shown) surface to avoid occlusion of the image. Pockets are machined into the rotors for receiving magnets. As is conventional, the pockets are oversized with respect to the PM they are designed to retain, typically with two ends 26 thereof extending around the PM after insertion. The modelling assumes PCM can be inserted here.

For thermal FEA modeling, the casing 15 is assumed to have the properties of aluminum, the coils 14 are equivalent to copper (loss hypothesis 27a), stator (27b) and rotor (27c) core losses are modelled, an insulation shroud 16 (identified at a few locations only) is modelled surrounding the copper coils (loss hypothesis 27e), as well as those of the permanent magnet (27d) (with and without the PCM embedded). Furthermore, convective cooling of the casing to air (27f), and of casing to coolant (27g) were modelled. Contact thermal resistance between casing and stator lamination (27h) was assumed to have a 0.037 mm gap. The magnets were assumed to have a 0.1 mm interface gap (27i), and the shaft is assumed to have a 0.037 mm interface gap (27j) where it joins the rotor 22. Finally, a shaft to bearing, and bearing to casing were associated with 0.3 mm interface gaps (loss hypothesis 27k).

### Magnet Temperature Simulation

The magnet temperature distribution was simulated with and without an integrated Erythritol PCM filling rotor pocket-ends 26. Hypothesis on the heat transfer coefficients and air gap measurements in the motor are given in FIG. 3a. The motor configuration is illustrated in FIGS. 1a and 1b as well as in FIG. 3a-c. Erythritol PCM was simulated in the pocket-ends 26 located at the end of the magnet for some simulations (see FIG. 9a for enlargement).

FIGS. 5a and 5b are plots showing the average magnet side temperature during uphill drive and highway acceleration. Transient time is defined as the time required for the magnet temperature to reach a certain value under given fixed operating conditions. For illustration, the data for a temperature of 150° C. is given in tables 1 and 2 below. It is worth noting that the PCM effect is significant as it increases the transient time by up to 81% for the uphill drive condition and 83% for the highway acceleration condition.

TABLE 2
Uphill drive

| | Time for Maximum | Time for magnet side |
|---|---|---|
| | magnet temperature to | temperature to reach 150° C. |
| No PCM (s) | 5.88 s | 10.90 s |
| PCM (s) | 10.36 s | 19.70 s |
| Δ transient | 76.02% | 80.83% |

TABLE 3
Highway acceleration:

| | Time for Maximum magnet | Time for magnet side |
|---|---|---|
| | temperature to reach | temperature to reach |
| No PCM (s) | 10.39 s | 18.62 s |
| PCM (s) | 18.66 s | 34.06 s |
| Δ transient | 79.47% | 82.96% |

FIG. 6 shows that the PCM in the surrounding pockets substantially reduces the temperature of the PM after 15 s of uphill drive.

### PCM Temperature Simulation

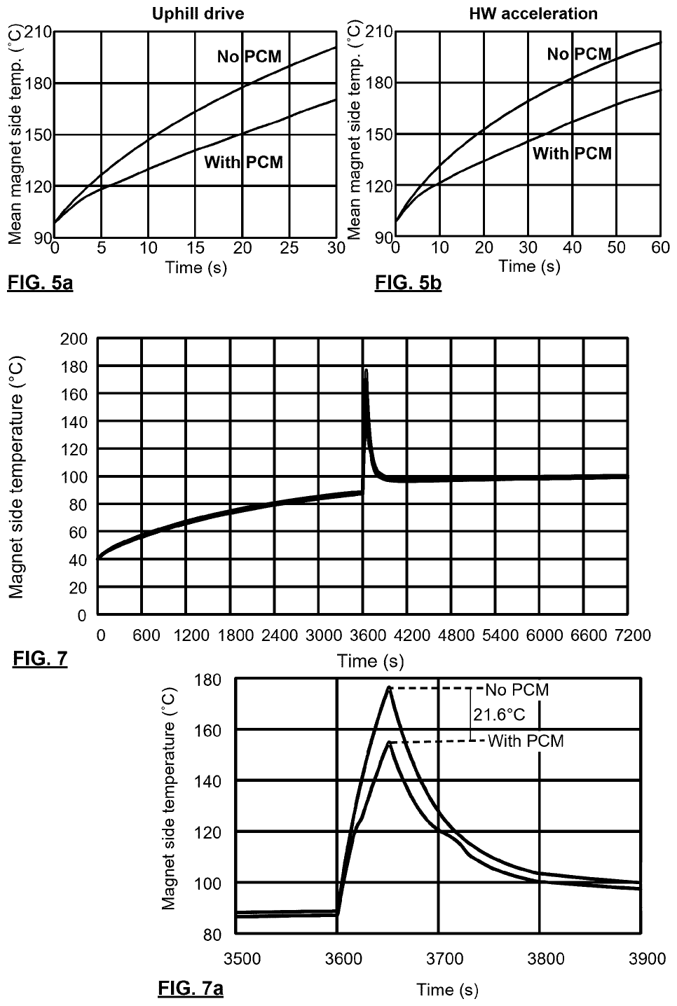

FIG. 7 shows simulation results for a driving scenario where a high peak power (50 KW) is demanded of the electric motor for a short period of time (60 s) after the motor was used for 1 h under lighter demand conditions. Afterwards the motor was returned to light duty according to this scenario. FIG. 7 is a graph of the magnet side temperature as a function of time. FIG. 7a shows an enlargement of the graph in the vicinity of the 1 minute of peak demand. The PCM allows for a reduction of the maximum temperature of almost 22° C., which is significant protection for the magnet. It could, for example, allow for the design to use lower grade magnets and lower the total motor cost.

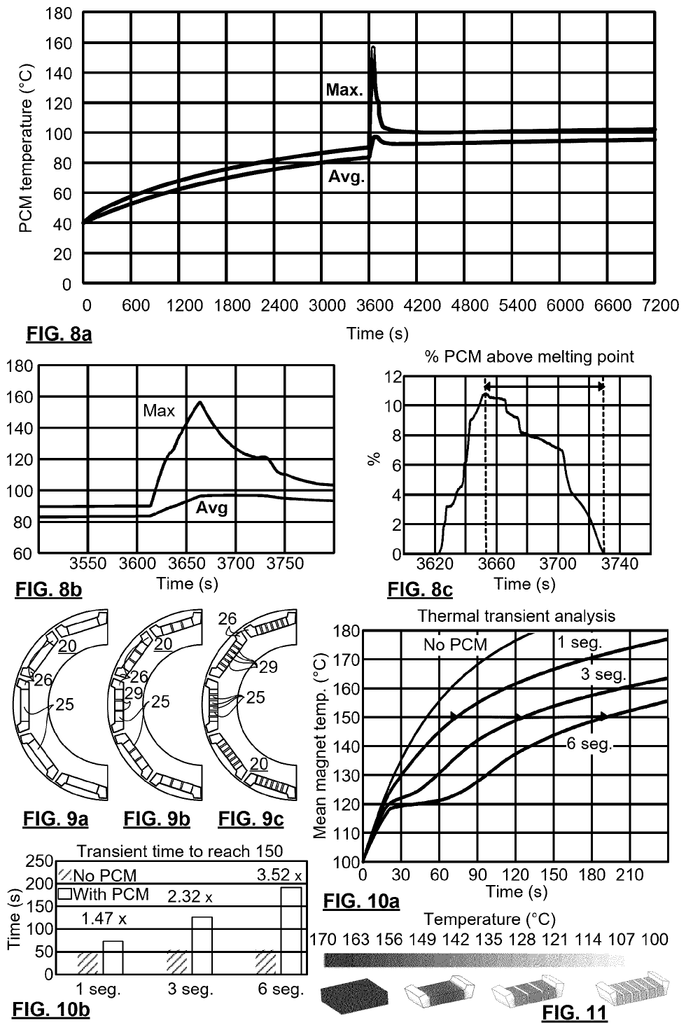

FIG. 8a, and its enlargement 8b, show the maximum and average PCM temperature observed during the driving scenario in FIG. 7. The deviation between the average and maximum temperatures indicates a non-uniformity of the magnet temperature distribution due to PCM concentration at the magnet sides. FIG. 8c show the percentage of effective PCM material that has exceeded its melting temperature of 118° C. The results show that only 10.5% of the PCM volume is contributing to TRL. The bulk of the PCM volume is not being leveraged with this configuration. FIG. 8c also shows that the PCM solidifies again after 80 seconds of reaching peak temperature, rendering it ready for another transient operation.

### Magnet Segmentation

In order to better protect the magnet and make full use of the PCM, 3 segmentation designs of the PM were simulated. Each of FIGS. 9a-c shows a (half) rotor 20, with the 5 PMs 25 mounted to it, and 2 pockets 26 flanking each respective PM. FIG. 9a shows a so-called one magnet segmentation where the PCM is limited to the flanking pockets 26. FIG. 9b shows a 3-magnet segmentation design that provides adds 2 gaps 29 that can notionally be filled with PCM. FIG. 9c shows a 6-magnet segmentation, and thus provides 5×5=25 gaps 29 along with the 10 pockets 26.

The three rotor designs in FIGS. 9.a, 9.b and 9.c were simulated using electromagnetic FEA to evaluate the motor performance. Thermal FEA analysis of the complete motor structure is then performed with simulated Erythritol PCM filling the rotor gaps.

For a fair comparison, the following design constraints were implemented for the three rotor designs in FIGS. 9a-9c:
Magnet area=189.5 mm²
PCM area=75.5 mm² (±2%)
Output torque at current density of 20 A/mm²=186 Nm (±3%)

It was assumed that all 3 designs had the same loss density with uniform distribution in order to evaluate the PCM effectiveness.

### Magnet Segmentation—Thermal Analysis

FIG. 10a shows the thermal transient analysis of the segmentation designs of FIGS. 9a-9c. FIG. 10b shows the difference between the transient time to reach 150° C. for the segmentation designs of FIGS. 9a-9c when a PCM is either present or the gaps between the magnets are filled with air, i.e. there is no PCM. One can see from FIGS. 10a and 10b that the PCM becomes more effective in extending the transient period when it is utilized with more magnet segments, as the higher interface area between the PCM and magnets improves the extraction of magnet-generated heat during the phase changing period of PCM. FIG. 11 shows the temperature distribution of the magnet without PCM as well as the 3 segmentation designs of FIGS. 9a-9c at the 90 seconds data point of FIG. 10a. The more PCM segments present, the cooler is the magnet at 90s, although there is a diminishing return going from 3 to 6 compared with 1 to 3. Notice that the curves are all similar before the melting point of the PCM is reached.

### Integrated Cavities

Retaining and assembling a rotor as shown in either of FIGS. 9b,c may be challenging, though obviously desirable from a TRL perspective. FIG. 12 is a panel showing another configuration of the PM with an integrated PCM. The integrated PCM is provided for with a cavity or recess 30 extending at least partway through the PM, and as such a large surface area provides contact between the PCM and PM. While some forming routes may invariably produce a residual layer or coating at this interface, a thermal resistance of which being small, the directness of the contact, and the area of the contact relative to the volume of the PCM, are useful for better leveraging the PCM TRL effects.

The top of FIG. 12 show the segmented PM of FIG. 9c in a side view (left side), and thermal model of the PM and the PCM in the pockets as well as in the gaps 29 are illustrated. A temperature scale is provided to show how effective the TRL is with this design. The dark bands at the tops of the PCM are very cool relatively (˜105° C.).

On the right side of panel 12, the top shows a design for a PM with elongated lozenge-shaped through bores or cavities 30. The thermal modeling shows better suited TRL of this PM for the operating conditions, than the left side segmented model, in that the temperature is more uniform in the model. It can be seen from the thermal models that the peak temperatures in view at the surfaces are well below 132° C. for both for the segmented PM and PM with integrated cavities. The models in the thermal distributions (middle) and heat flux (bottom) are presented in a perspective view. The heat flux distribution shows a substantial difference in cooling rates at the edges of the PCM in the segmented PM, as opposed to the PM with integrated cavities.

FIG. 13 is a graph of mean temperature for these two PMs. The temperature rise for both configurations is equivalent in the scenario given. However, the configuration with the integrated cavities has significant practical advantages. Indeed, using that configuration, one can enclose the PCM material thus preventing leakage during operation under centrifugation, with a molten or partially molten mass of PCM material.

TABLE 3
Magnet area and Mean Torque of segmented vs. integrated cavity:

| | Segmented | Integrated |
|---|---|---|
| Magnet area | 189.5 | 187.5 |
| PCM area (mm2) | 148 | 150 |
| Average torque | 190.3 | 187.1 |

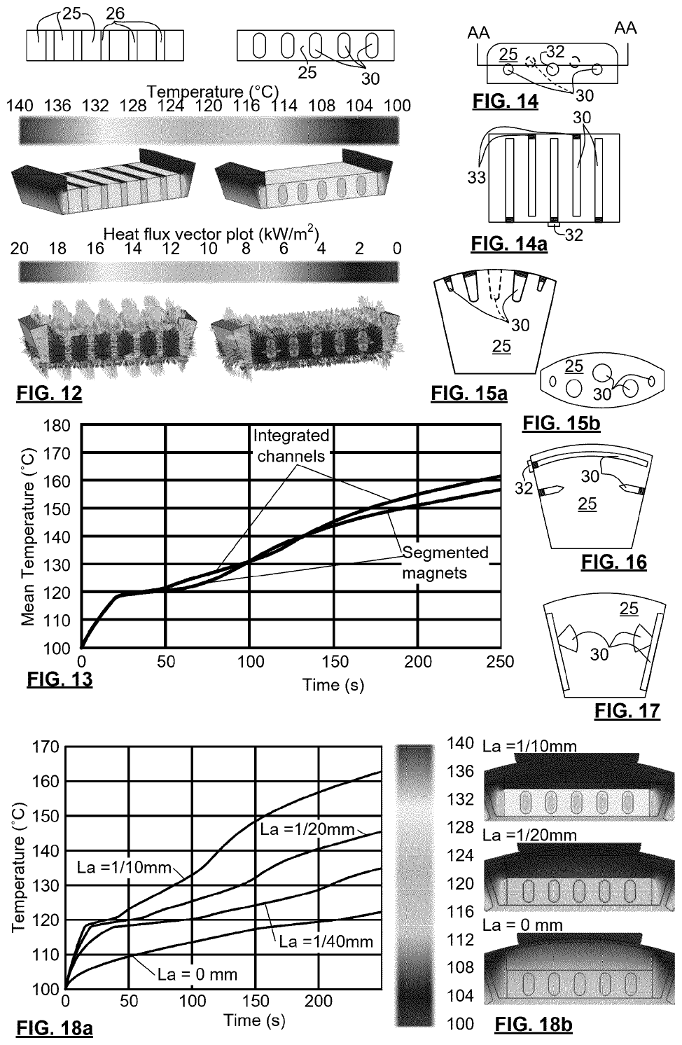

FIG. 14 is a side view of a variant of the PM 25 with a different arrangement of cavities 30. There are 5 cavities 30 shown, three extending from the face in view, and two are shown in ghost view. FIG. 14a shows a cross-section image taken along view lines AA. The cavities 30 are elongated and similar, each extending in parallel from one of two opposite sides of the PM 25. At the end of each cavity 30, near where it meets the respective side, box threads 33 are tapped to engage pin threads of a cap 32 that is shown mounted in one of the cavities 30.

The three cavities 30 that meet the surface shown in FIG. 14 are lower than the 2 cavities meeting the opposite face, to better distribute PCM within the PM, and to reduce distances between the cavities 30. This design can be fabricated using any of the methods of I-IV listed hereinabove.

FIG. 15a, b show a cross-sectional view, and side elevation view, of a second variant of PM 25 in accordance with the present invention. This embodiment shows again 5 cavities, two of which are smaller than three others. The cavities are frustoconical, with rounded distal faces. There are a variety of shapes that can be machined into a PM with sufficient UTS. This design may be apposite to cool the face shown in FIG. 15b (first face), if that is where heat builds up. Providing smaller holes in narrower parts and larger holes in thicker parts of the PM is logical to avoid stress concentration within the PM. The axes of the cavities 30 shown in the second variant are not parallel, although they may be coplanar. Each axis is essentially perpendicular to the first face locally, and this face is curved at least one direction. This design too can be fabricated using any of the methods of I-IV listed hereinabove.

FIG. 16 show a cross-sectional view of a third variant of PM 25 in accordance with the present invention. The third variant has a sub-surface elongated cavity that extends substantially conformally with a top (as shown) surface of the PM 25. The third variant also has two, symmetrically opposed cavities having non-continuous shapes: the shapes consist essentially of a cylindrical bore with a conical tip. This design can be fabricated by additive manufacturing if a sacrificial material or tube is used in the design.

FIG. 17 show a cross-sectional view of a fourth variant of PM 25 in accordance with the present invention. The fourth variant's cavities are two elongated grooves along opposite side edges, and a narrow fan-slit structure that intrudes towards a centre of the PM 25. Each fan-slit structure is connected to its respective groove, and therefore there are technically only 2 cavities. Covering this structure is not as simple a matter as it was for the previous variants.

### Prototype

Applicants has produced an example of a PM in accordance with the present invention. The PM was deposited on a coupon 36.7×28.8×14.5 mm of Al 6061. NdFeB magnet samples were prepared by cold spray additive manufacturing using MQFP-B NdFeB powder from Magnequench and H5 aluminium powder from Valimet. The samples were processed using a temperature of 600° C. and a gas pressure of 4.9 MPa. More details on the magnet fabrication procedure as well as on their magnetic properties can be found in Lamarre, J.-M., Bernier, F., Permanent Magnets Produced by Cold Spray Additive Manufacturing for Electric Engines, (2019), Journal of Thermal Spray Technology, 28 (7), pp. 1709-1717, the content of which is hereby incorporated by reference.

The sample surface was machined to final dimensions while holes to insert Erythritol and thermocouples were drilled using conventional machining for demonstration purposes. The three main cavities were completely filled with a total of 2.32 g of liquid Erythritol.

A test rig was used to test service conditions of the PM material. Heat was supplied via a 3 KW CO₂ laser (50 W, 163 pulse duration, laser spot 25 mm diameter) and temperature measurements were provided by thermocouples, optical pyrometers, and a thermal camera. The excellent agreement between simulated thermal distribution and that predicted by simulation affords a very high confidence in the simulated results provided hereinabove. Under conditions where a PM with no PMC or slots heated to 180° C., the PM with PMCs was found to be below 160° C.

A PM has therefore been disclosed, as well as a method of fabrication. The provision of holes in PM to provide cavities for retaining PCM is demonstrated to provide a viable fabrication route and well supported improvements in thermal regulation of PMs. While the PM can advantageously be produced by AM, preferably CSAM, directly on a rotor substrate, a PM of the same strength can be produced by other routes making a variety of designs more amenable to deployment in rotors of electric machines.

1. A permanent magnet (PM) for use in an electric machine, said PM containing a phase change material (PCM) integrated with said PM, the PCM having a phase transition temperature between about 80° C. to about 200° C.

2. The PM of claim 2 wherein said phase transition temperature is between 150° C. to about 250° C.

3. The PM of claim 1 wherein the PCM has a latent heat of at least 50 KJ/kg.

4. The PM of claim 1 wherein the PCM is selected from Paraffin, Erythritol or a combination thereof.

5. The PM of claim 1, wherein said PM comprises a plurality of cavities in which the PCM is integrated.

6. (canceled)

7. (canceled)

8. The PM of claim 5 wherein each cavity is a blind, elongated chamber extending from one side of the PM, having two smaller dimensions and a larger dimension, and the larger dimensions of each cavity are oriented substantially in a same direction.

9. The PM of claim 8 wherein each cavity has a cylindrical or tabular shape, whereby the cavity is consistent with manufacture by drilling one or more overlapping bores.

10. The PM of claim 1, said PM being composed of a permanent magnet material, comprising a hard magnetic phase, and a binder phase, the PM having an ultimate tensile strength of at least 150 MPa.

11. The PM of claim 10, wherein said hard magnetic material consists essentially of an AlNiCo alloy, a NdFeB alloy, a SmCo alloy, a SmFeCo alloy, or a combination thereof.

12. The PM of claim 10 wherein the hard magnetic material consists essentially of NdFeB, or an alloy NdFeB alloy.

13. The PM of claim 10, wherein the binder consists essentially of Al, Cu, Ti, Zn, Fe, Ni, Ag, Au, an alloy thereof, or a combination thereof.

14. The PM of claim 13, wherein the binder is Al, or an alloy thereof.

15. The PM of claim 10 wherein the PM is composed of 34 vol % to 85 vol % of the hard magnetic phase.

16. The PM of claim 10 wherein the PM is composed of approximately 50 vol % to approximately 75 vol % of the hard magnetic phase.

17. The PM of claim 1 mounted to a rotor for an electric machine.

18. A rotor with a PM of claim 8 mounted to it, wherein the larger dimensions of each cavity is oriented parallel to an axis of rotation of the rotor and if 2 or more bores are drilled, they are arrayed radially outwardly from the axis of rotation.

19. The rotor of claim 17 wherein a join between the PM and rotor is consistent with the formation of the PM by additive manufacturing (AM) on the rotor, whereby bonding the PM to the rotor is accomplished during manufacture of the PM.

20. The rotor of claim 19 wherein the join is consistent with the formation by cold spray additive manufacturing.

21. The rotor of claim 17 mounted to an axle and a stator to produce an electric machine.

22. A method of manufacturing a permanent magnet (PM), said method comprising:
providing a permanent magnet material, and forming the PM by additive manufacturing directly on a substrate using the permanent magnet material;
finishing the PM and producing or finishing a cavity within the PM for retaining a phase change material;
integrating the phase changing material into the PM; and
enclosing the cavity.
